(19) United States
(12) Patent Application Publication
(10) Pub. No.: US 2013/0281218 A1
(43) Pub. Date: Oct. 24, 2013

(54) ROTARY VIBRATION DAMPER

(71) Applicants: Johann Loew, Garching (DE); Franz Kobus, Jettenbach (DE)

(72) Inventors: Johann Loew, Garching (DE); Franz Kobus, Jettenbach (DE)

(73) Assignee: SGF Suedeutsche Gelenkscheibenfabrik Gmbh & Co KG, Waldkraiburg (DE)

(21) Appl. No.: 13/880,389

(22) PCT Filed: Sep. 6, 2011
(86) PCT No.: PCT/EP2011/004484

§ 371 Date: Jul. 11, 2013

(30) Foreign Application Priority Data
Oct. 22, 2010 (DE) 10 2010 049 320.1

(51) Int. Cl. F16F 15/14; F16D 3/12; F16F 7/108

(52) U.S. Cl. CPC F16F 15/1457; F16F 7/108; F16D 3/12
USPC 464/87; 188/379

(57) ABSTRACT

The present disclosure relates to a vibration damper, in particular for a drive train of a motor vehicle, having a support body which is rotatable about an axis of rotation M, a damper mass which is coaxial with respect to the support body and which is arranged with a radial spacing to the support body, and a plurality of spring elements which connect the support body and the damper mass to one another. It is provided that the support body has axial travel limiting means which extend on the support body in the radial direction relative to the damper mass so as to limit a displacement of the damper mass in the axial direction relative to the support body.

The present invention relates to a rotary vibration damper having a support body which is rotatable about an axis of rotation, a damper mass which is coaxial with respect to the support body and which is arranged with a radial spacing to the support body, and a plurality of spring elements which connect the support body and the damper mass to one another. The present invention further relates also to a device for transmitting torques for a drive train of a motor vehicle.

Rotary vibration dampers of the previously described type are prior art and disclosed for example in the document DE 29 33 586 C2. The rotary vibration damper according to this document comprises a star-shaped hub and a flywheel that surrounds the hub in radial direction. The flywheel is connected to the hub by a plurality of rubber elements that are distributed on the circumference. Through-holes are further disposed in the hub for fastening to shaft portions.

If in such a vibration damper the rubber- and/or spring elements should fail, for example sever as a result of material fatigue, the flywheel of the vibration damper may become detached and move freely along the shaft. In so doing, it may damage adjacent vehicle components, such as for example a fuel tank, thereby possibly leading also to an increased risk of endangering the occupants of the vehicle.

It is accordingly an object of the present invention to provide a vibration damper of the type described in the introduction that, while being of a simple design that is inexpensive to manufacture, is also capable of holding the damper mass in a predetermined position even in the event of failure of the spring elements.

This object is achieved with a vibration damper of the type described in the introduction in that the support body has axial travel limiting means, which extend on the support body in the radial direction relative to the damper mass so as to limit a displacement of the damper mass in the axial direction relative to the support body.

By virtue of the arranging of axial travel limiting means that extend from the support body in radial direction relative to the damper mass, the damper mass may be held at a predetermined position, i.e. in the region of the axial extent of the support body, even in the event of failure of the spring elements. In other words, in the event of failure of the spring elements and/or the rubber contour the axial travel limiting means prevent an undesirable “migration” of the damper mass along the shaft portion, to which the vibration damper is fastened. As the damper mass is held in a predetermined position by the axial travel limiting means, damage to adjacent vehicle components, such as for example the fuel tank, as a result of displacement of the damper mass may be ruled out.

According to an embodiment of the invention it is provided that the axial travel limiting means are arranged spaced by a predetermined distance in axial direction from the damper mass. During normal operation the vibration damper is, as far as possible, not to be influenced by the axial travel limiting means. Since the damper mass during normal operation may shift, albeit to a slight extent, in axial direction, the axial travel limiting means are arranged at a distance from the damper mass.

To enable the axial travel limiting means to be formed on the support body without an increased outlay during the manufacturing process, according to the invention it is provided that the axial travel limiting means of the support body are formed integrally therewith at least on one axial side. If the support body is for example a sheet-metal part, the axial travel limiting means may be formed directly on the support body during a stamping- and deep-drawing process.

So that the damper mass may be secured against an unintentional displacement and/or held in a predetermined position at both sides, there are preferably provided on both axial sides of the support body axial travel limiting means that extend in radial direction relative to the damper mass.

So that the vibration damper may be mounted on further components, for example an articulated body, according to an embodiment of the invention it is provided that the support body has location holes, in which connecting bushes that extend in axial direction from the support body are received.

As already mentioned above, the axial travel limiting means may be formed integrally with the support body. If however the rotary vibration damper is to be connected to further components, such as an articulated body, then according to the invention the axial travel limiting means may be formed integrally with the support body at an opposite axial side thereof to the connecting bushes.

The support body of the rotary vibration damper may be a sheet-metal part. In this connection, with regard to the mechanical construction of the support body it should be mentioned that the support body according to an embodiment of the invention is of a pot-like construction comprising a base plate and a circumferential wall. In this case, according to the invention the axial travel limiting means may be formed integrally with the support body at the opposite side of the wall of the support body to the base plate and the location holes for receiving the connecting bushes may be provided in the base plate.

In order to secure the damper mass in its predetermined position, according to an embodiment of the invention in addition to the axial travel limiting means formed integrally with the support body axial travel limiting means may also be provided on the connecting bushes.

As has already been indicated several times, rotary vibration dampers of the previously described type are often used in conjunction with an articulated body as this allows the advantages of these two components to be combined in a relatively small installation space.

The present invention accordingly further relates to a device for transmitting torques for a drive train comprising a vibration damper of the previously described type and an articulated body, which has a plurality of location bushes. The location bushes are arranged in circumferential direction at predetermined angular intervals relative to the axis of rotation of the articulated body. According to the invention for connecting the articulated body to the vibration damper in a first group of the location bushes of the articulated body the connecting bushes of the vibration damper are at least in sections received.

With such a device it is possible firstly to dampen rotary vibrations, in particular vibrations of specific frequencies, that arise in a drive train of a motor vehicle. On the other hand, by means of the articulated body of the device according to the invention, for example a so-called flexible disk, it is possible by virtue of the elastic deformability of the flexible disk to achieve a compensating function, by means of which axial offset or inclinations of two shaft portions that are to be connected to one another may be compensated.

In order to be able to secure the damper mass of the rotary vibration damper at both sides in axial direction also in the device according to the invention, between the support body of the vibration damper and the articulated body the axial travel limiting means are arranged so as to be able to limit a displacement of the damper mass in axial direction relative to the support body. In other words, the axial travel limiting means are clamped in between the vibration damper and the articulated body.

The axial travel limiting means are in this case arranged according to the invention on the connecting bushes. The axial travel limiting means according to this embodiment may be applied at least in sections against the base plate of the support body and the location bushes of the articulated body.

In order to connect the device according to the invention and/or the articulated body to a shaft portion, according to the invention fastening bushes are received in a second group of the location bushes of the articulated body for coupling the articulated body to a portion of a vehicle drive train.

The invention is described below by way of example with reference to the accompanying figures. These show in:

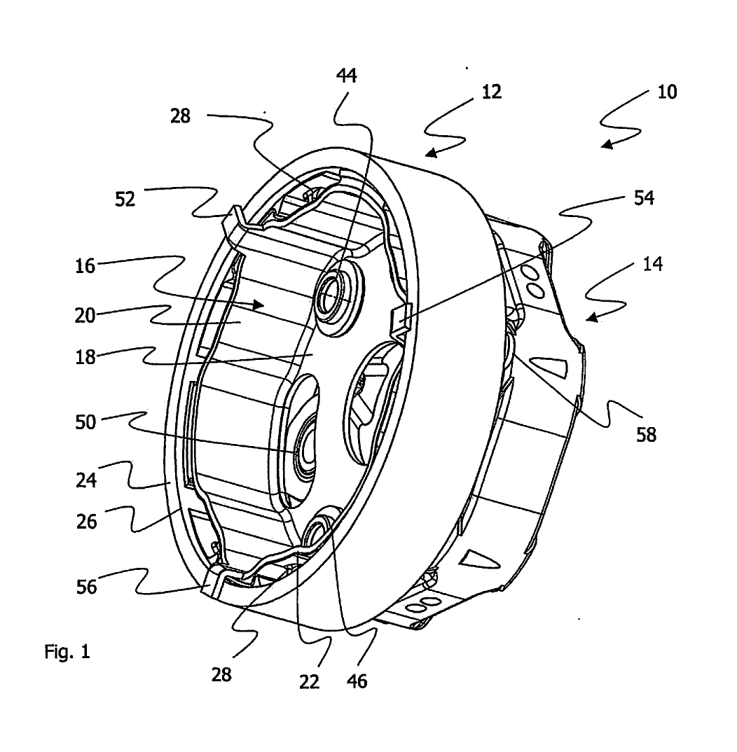

FIG. 1 a first perspective view of the device according to the invention;

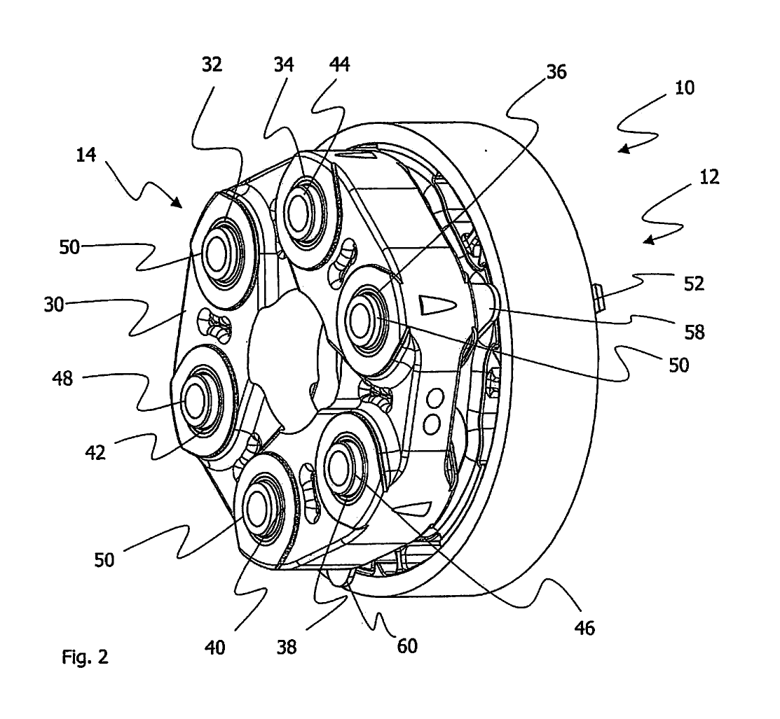

FIG. 2 a second perspective view of the device according to the invention;

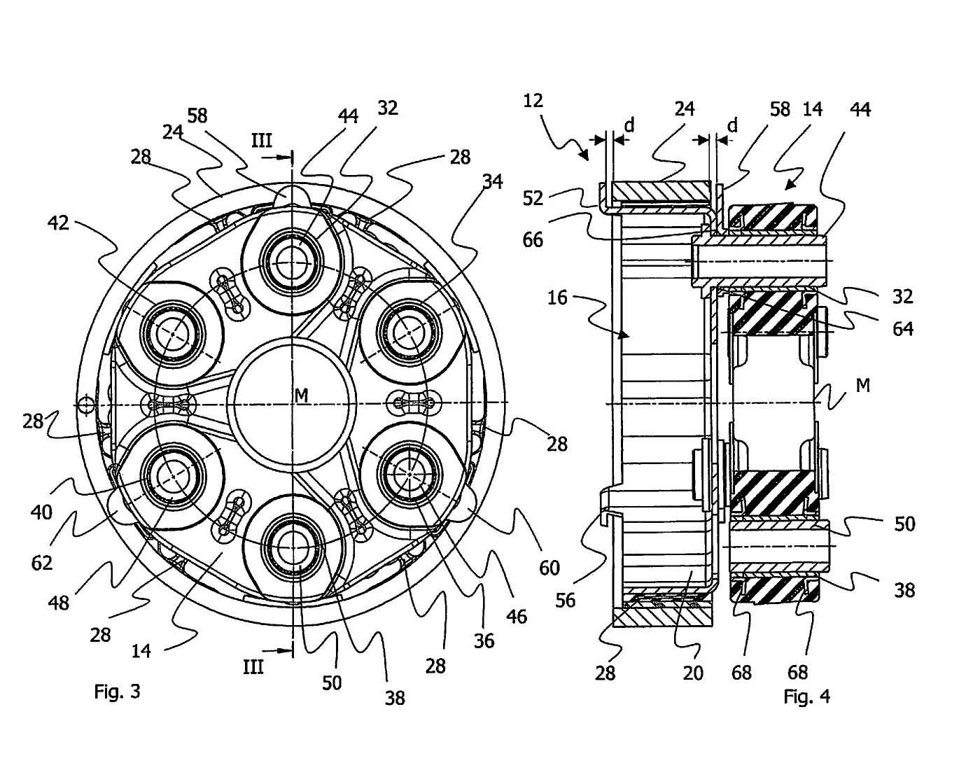

FIG. 3 a front view of the device according to the invention; and

FIG. 4 an axis-containing sectional view of the device according to the invention according to the cutting line III-III of FIG. 3.

In FIGS. 1 and 2 a device according to the invention is shown in different perspective views and generally denoted by 10.

The device 10 in this case comprises a rotary vibration damper 12 and an articulated body in the form of a flexible disk 14. The rotary vibration damper 12 comprises a pot-like support body 16, which is configured with a perforated base plate 18 and a corrugated wall 20. The support body 16 is manufactured in the form of a sheet-metal part that is deep-drawn, formed or wrought in some other way. The wall 20 and/or its outer circumferential surface 22 is surrounded by a hollow-cylindrical damper mass 24. Vulcanized in between the outer peripheral surface 22 of the wall 20 and an inner circumferential surface 26 of the damper mass 24 is an elastomer rubber layer 28, which acts as a spring element to allow the damper mass 24 to rotate to a specific extent relative to the support body 16. The rubber layer 28 may be locally interrupted, i.e. have defined rubber webs. It may also further include guide elements, such as for example sliding blocks, thereby guaranteeing a defined relative rotation between support body 16 and damper mass 24. Altogether with this arrangement of support body 16, damper mass 24 and the rubber layer 28 disposed therebetween a rotary vibration damping effect may be achieved.

The flexible disk 14 comprises an elastic disk body 30, in which cylindrical location bushes 32, 34, 36, 38, 40, 42 are embedded (FIG. 2). In a first group of the location bushes 32, 34, 36, 38, 40, 42 connecting bushes 44 and 46 are received, traces of which may be seen in FIG. 1. The connecting bushes 44, 46 and 48 (FIG. 2) are received in the corresponding first group of the location bushes 32, 34, 36, 38, 40, 42 in order to connect the rotary vibration damper 12 to the articulated body 14.

FIGS. 1 and 2 moreover reveal that in a second bush group of the location bushes 32, 34, 36, 38, 40, 42 fastening bushes 50 are received, via which the articulated body 14 and/or the device 10 is mountable on a non-illustrated flange of a shaft portion.

In FIG. 1 it is further evident that the connecting bushes 44, 46 are mounted on the perforated base plate 18 of the support body 16.

Axial travel limiting means 52, 54, 56, 58 are moreover shown in FIGS. 1 and 2. The axial travel limiting means 52, 54, 56 extend in radial direction from the support body 16 relative to the damper mass 24 in order in the event of failure of the spring elements 28 to be able to hold the damper mass 24 in a predetermined position. The axial travel limiting means 52, 54, 56 are lug-shaped and formed integrally with the support body 16.

The axial travel limiting means 58, 60 are disposed between the rotary vibration damper 12 and the articulated body 14 and extend outwards likewise in radial direction in order, if need be, to be able to limit a displacement of the damper mass 24 in the direction of the articulated body 14.

In other words, the axial travel limiting means 52, 54, 56 are mounted on the opposite axial side of the support body 16 and/or the wall 20 to the base plate 18, while the axial travel limiting means 58, 60 are applied against the base plate 18.

The configuration of the axial travel limiting means 52, 54, 56 that is shown in FIG. 1 enables easy manufacture of the axial travel limiting means 52, 54, 56 as the lugs may be formed together with the support body 16 during manufacture of the support body 16, for example during a deep-drawing process, and need merely be bent over after completion of the rotary vibration damper 10.

A combined viewing of FIGS. 1 and 2 reveals that in the device 10 by means of the axial travel limiting means 52, 54, 56, 58, 60 the damper mass 24 may be held in a predetermined position, i.e. substantially always in the region of the axial extent of the support body 16, even in the event of failure of the spring elements 28.

FIG. 3 shows a front view of the device 10 and FIG. 4 shows a sectional view of the device 10 along the cutting line III-III of FIG. 3.

Evident once more are the rotary vibration damper 12 and the flexible disk 14, which are connected to one another by connecting bushes 44, 46 and 48 (in FIG. 4 only the connecting bush 44 is shown). Provided in the base plate 18 for receiving the connecting bushes 44, 46, 48 are location holes 64, in which the connecting bushes 44, 46, 48 are accommodated. The connecting bushes 44, 46, 48 further comprise a circumferential projection 66, with which they rest against the base plate 18. The connecting bushes 44, 46 and 48 are connected to the base plate 18 of the support body 16 in a fixed manner, being for example welded to or press-fitted on the base plate 18.

The articulated body 14 is press-fitted by means of a first group of the location bushes 32, 34, 36, 38, 40, 42 onto the connecting bushes 44, 46, 48. In the second group of the location bushes 32, 34, 36, 38, 40, 42 fastening bushes 50 are received, by means of which the device 10 is mountable on a flange of a portion (not shown here) of a drive train.

Clearly visible in FIGS. 3 and 4 are the axial travel limiting means 58, 60 and 62, which are disposed between the rotary vibration damper 12 and the articulated body 14 and which secure the damper mass 24 in axial direction in order to prevent an undesirable detachment and “migration” of the damper mass 24 in the direction of the articulated body 14. The axial travel limiting means 58, 60 and 62 are disposed on the connecting bushes 44, 46, 48 and are clamped in between the articulated body 14 and the rotary vibration damper. The axial travel limiting means 58, 60 and 62 extend likewise in radial direction relative to the damper mass 24 in order to prevent an unintentional displacement of the damper mass 24 in the direction of the articulated body 14. To this end they are applied in sections against the base plate 18 and the first group of the location bushes 32, 34, 36, 38, 40, 42.

In FIG. 4 moreover the axial travel limiting means 52, 56 are shown once more, which are formed integrally with the support body 16 of the rotary vibration damper 12 and extend in radial direction in order to be able to hold the damper mass 24 in its predetermined position in the event of failure of the spring contour 28.

In the state of rest the axial travel limiting means 52, 54, 56, 58, 60, 62 are disposed at a predetermined axial distance d from the damper mass 24 so as not to come into contact with damper mass 24 during normal operation of the rotary vibration damper 12 and/or the device 10. Since even during normal operation of the rotary vibration damper 12 axial excursions of the damper mass 14 relative to the support body 16 are possible—albeit to a slight extent—the predetermined distance between the axial travel limiting means 52, 54, 56, 58, 60, 62 and the damper mass 24 is necessary to prevent the function of the damper mass 24 from being influenced or impeded by the axial travel limiting means 52, 54, 56, 58, 60, 62 during normal operation of the rotary vibration damper 12.

Further evident in FIG. 4 are the spring elements 28 that connect the support body 16 and the damper mass 24 to one another. Should the spring contour as a whole and/or the spring elements 28 tear, there is no longer a connection between the support body 16 and the damper mass 24, i.e. the damper mass would become freely movable axially along the shaft portion (not shown) and could damage adjacent components of a vehicle. For this reason the axial travel limiting means 52, 54, 56, 58, 60, 62 are arranged, which hold the damper mass 24 in position even in the event of failure of the spring elements 28.

Further evident in FIG. 4 are flange bushes 66, which are disposed on the axial ends of the location bushes 32, 34, 36, 38, 40, 42.

The axial travel limiting means 52, 54, 56 and 58, 60, 62 are arranged offset by a predetermined angle to one another on the support body 16 and the connecting bushes 44, 46, 48 respectively. The axial travel limiting means 52, 54, 56, which are formed integrally with the support body 16, and the axial travel limiting means 58, 60, 62, which are disposed between vibration damper 12 and articulated body 14, lie directly opposite one another so that the damper mass 24 is held in its position.

By means of the axial travel limiting means 52, 54, 56, 58, 60, 62 the damper mass 24 may be secured in its position in both axial directions, with the result that a “migration” along a shaft portion and possible damage of adjacent vehicle components, such as the fuel tank, may be effectively avoided. Should the damper mass 24 become detached from the spring contour 28 and/or the support body 16, the damper mass 24 after travelling beyond a predetermined distance comes into contact with the axial travel limiting means 48, 50, 52, 54, 56, 58 and is therefore secured in its predetermined position.

The axial travel limiting means 48, 50, 52, 54, 56, 58 may moreover in principle also limit the axial travel of a damper mass that is still connected in an intact state to the support body 16 by the rubber layer 28, thereby making it possible to avoid extreme deflections. The service life of the vibration damper according to the invention may consequently be prolonged, as it is precisely such deflections of the damper mass beyond the distance d relative to the support body that may lead to extreme wear in the region of the rubber layer.

1. A vibration damper for a drive train of a motor vehicle, comprising:
a support body which is rotatable about an axis of rotation;
a damper mass which is coaxial with respect to the support body and which is arranged with a radial spacing around the support body; and
an elastomer layer comprising a plurality of spring elements, which connect the support body and the damper mass to one another, and radial guide elements, which are configured to guarantee a defined relative rotation between the damper mass and the support body,
wherein the support body has axial travel limiting flange which extend on the support body in the radial direction relative to the damper mass so as to limit a displacement of the damper mass in axial direction relative to the support body.

2. The vibration damper according to claim 1, wherein the axial travel limiting flange are arranged spaced by a predetermined distance in an axial direction from the damper mass.

3. The vibration damper according to claim 1, wherein the axial travel limiting flange are formed integrally with the support body at least on one axial side thereof.

4. The vibration damper according to claim 1, wherein on both axial sides of the support body axial travel limiting flange are provided, which extend in a radial direction relative to the damper mass.

5. The vibration damper according to claim 1, wherein the support body comprises location holes, in which connecting bushes that extend in axial direction from the support body are received.

6. The vibration damper according to claim 5, wherein the axial travel limiting flange are formed integrally with the support body on an opposite axial side thereof to the connecting bushes.

7. The vibration damper according to claim 1, wherein the support body is of a pot-like construction comprising a base plate and a circumferential wall.

8. The vibration damper according to claim 7, wherein the axial travel limiting flange are formed integrally with the support body on the opposite side of the circumferential wall to the base plate, and the location holes for receiving the connecting bushes are provided in the base plate.

9. The vibration damper according to claim 5, wherein the axial travel limiting flange are disposed on the connecting bushes.

10. A device for transmitting torques for a drive train of a motor vehicle, comprising:
a vibration damper according to claim 5; and
an articulated body comprising a plurality of location bushes, which are arranged in circumferential direction at predetermined angular intervals relative to the axis of rotation of the articulated body,
wherein for connecting the articulated body to the vibration damper in a first group of the location bushes of the articulated body the connecting bushes of the vibration damper are at least partially received, and
wherein between the support body of the vibration damper and the articulated body the axial travel limiting flange are disposed in such a way that they limit a displacement of the damper mass in axial direction relative to the support body.

11. The device according to claim 10, wherein the axial travel limiting flange are disposed on the connecting bushes in such a way that they are applied at least in sections against the base plate of the support body and the location bushes of the articulated body.

12. The device according to claim 10 wherein a second group of the location bushes receives fastening bushes for coupling the articulated body to a portion of the drive train.
